(19) United States
(12) Patent Application Publication
(10) Pub. No.: US 2011/0131646 A1
(43) Pub. Date: Jun. 2, 2011

(54) APPARATUS AND METHOD FOR PREVENTING NETWORK ATTACKS, AND PACKET TRANSMISSION AND RECEPTION PROCESSING APPARATUS AND METHOD USING THE SAME

(75) Inventors: Chanho PARK, Daejeon (KR); Seong Woon KIM, Daejeon (KR); Sun Wook KIM, Daejeon (KR)

(73) Assignee: Electronics and Telecommunications Research Institute, Daejeon (KR)

(21) Appl. No.: 12/701,253

(22) Filed: Feb. 5, 2010

(30) Foreign Application Priority Data
Dec. 2, 2009 (KR) 10-2009-0118293

(51) Int. Cl. G06F 17/00

(52) U.S. Cl. 726/13

(57) ABSTRACT

An apparatus for preventing network attacks includes: a packet buffer for storing received packets from a network; a filtering unit for filtering harmful packets based on a result of comparison between information of the received packets and preset filtering information to select a first filtering target packet; an SYN cookie handler for selecting a second filtering target packet using an SYN cookie if it is determined that there is a TCP SYN flooding attack based on the information of the received packets after said filtering; and a session manager for selecting a third filtering target packet through session management if there is a TCP flag flooding attack based on the information of the received packets after said filtering. The apparatus further includes a packet transmission and receipt processing method and apparatus using above.

### CROSS-REFERENCE(S) TO RELATED APPLICATION

The present invention claims priority of Korean Patent Application No. 10-2009-0118293, filed on Dec. 2, 2009, which is incorporated herein by reference.

### FIELD OF THE INVENTION

The present invention relates to a defense against network attacks, and more particularly, to an apparatus and method for preventing network attacks and a packet transmission and reception processing apparatus and method using the same.

### BACKGROUND OF THE INVENTION

As well-known in the art, transmission control protocol/Internet protocol (TCP/IP) processing technique has been actively developed in the name of a TCP offload engine (TOE). These technologies are classified into a full-offloading technology for processing all protocols in a packet transmission/reception processing apparatus, for e.g., hardware such as a network card, and a partial-offloading technology for implementing only several functions by hardware and optimizing a data path.

Network security technologies can be roughly divided into a host based intrusion detection system (HIDS) and a network based intrusion detection system (NIDS) depending on where the functions are implemented. A HIDS applied to a server is generally implemented by software, and is lack of the ability to deal with a strong attack. It is still uncommon to use hardware for host-based security functions. An NIDS is configured at a network equipment in front of the server and implemented by hardware but is an expensive system which is in charge of the entire management network.

It is known that there is still no perfect technique for defending against network attacks, e.g., denial-of-service (DOS) attacks. One of the typical techniques for dealing with SYN flooding attacks, which are one of the most devastating DOS attacks, is a TCP intercept method. This is a method in which a router performs initial TCP connection and delivers only safe connections to a destination server. This method is disadvantageous in that a load of the router becomes too high in the event of a strong attack, and in serious case, the function of the router gets down. An SYN-cookie is implemented by software in a host-based manner, which is a method of encrypting and transmitting the PSN (packet sequence number) of an SYN-ACK (SYN acknowledgement) packet using a predetermined key value and then determining whether or not a client is safe based on the ACK number of the corresponding ACK packet. This method uses no memory for connection information but requires processing of a receiving SYN packet. Because this method is based on software, if the intensity of an attack exceeds a certain level, it is impossible to perform normal network protocol handling.

### SUMMARY OF THE INVENTION

Therefore, the present invention provides an apparatus and method for preventing network attacks, which allow for preventing attacks without using a large memory in the event of defense against network attacks, and a packet transmission and reception processing apparatus and method using the same.

In accordance with a first aspect of the present invention, there is provided an apparatus for preventing network attacks including: a packet buffer for storing received packets from a network; a filtering unit for filtering harmful packets based on a result of comparison between information of the received packets and preset filtering information to select a first filtering target packet if it is determined that there is a user datagram protocol (UDP) or Internet control message protocol (ICMP) flooding attack based on the information of the received packets after the filtering; and an SYN cookie handler for selecting a second filtering target packet using an SYN cookie if it is determined that there is a transmission control protocol (TCP) SYN flooding attack based on the information of the received packets after said filtering.

The apparatus further includes: a session manager for selecting a third filtering target packet through session management if it is determined that there is a TCP flag flooding attack based on the information of the received packets after said filtering; and a packet handler for filtering the first to third filtering target packets among the received packets stored in the packet buffer to forward the unfiltered received packets to the host, or forwarding all the received packets stored in the packet buffer to the host with the information of filtering target packets.

In accordance with a second aspect of the present invention, there is provided: a method for preventing network attacks including: filtering harmful packets based on a result of comparison between information of received packets from a network and preset filtering information; selecting a first filtering target packet if it is determined that there is a UDP or ICMP flooding attack based on the information of the received packets after the filtering; selecting a second filtering target packet using an SYN cookie if it is determined that there is a TCP SYN flooding attack based on the information of the received packets after the filtering; selecting a third filtering target packet through session management if it is determined that there is a TCP flag flooding attack based on the information of the received packets after the filtering; and filtering the first to third filtering target packets among the received packets from the network to forward the unfiltered received packets to a host, or forwarding information of the first to third filtering target packets to the host along with the received packets from the network.

In accordance with a third aspect of the present invention, there is provided a method for preventing network attacks including: determining whether or not there is a TCP SYN flooding attack based on information of packets received from a client; if it is determined that there is the TCP SYN flooding attack, determining whether or not the client is normal by using an SYN cookie; storing an IP of the normal client in a white list and then making a disconnection by transmitting a reset packet; when a connection request packet is received in the disconnected state, forwarding, to a server, a result of checking if the IP of the packet is stored in the white list to establish a connection with the client; and when the state of the TCP SYN flooding attack is released, initializing the white list.

In accordance with a fourth aspect of the present invention, there is provided a packet transmission and reception processing apparatus.

The apparatus includes: a first interface unit for providing a path for packet transmission and reception to and from a host; a transmission processing unit for reading out a transmission packet from the host via the first interface unit in response to a transmission command from the host; a checksum insertion unit for inserting a checksum into the transmission packet from the transmission processing unit and forwarding the transmission packet; a second interface unit for sending the transmission packet forwarded from the checksum insertion unit to a network and receiving the packet from the network; an error check unit for checking if there is an error in a header and checksum of the received packet forwarded from the second interface unit; a security function unit for determining whether or not the received packet forwarded from the error check unit is harmful; and a reception processing unit for sending the received packet forwarded from the security function unit to the host via the first interface unit.

In accordance with a fifth aspect of the present invention, there is provided a packet transmission and reception processing method.

The method includes: reading out a transmission packet from a host in response to a transmission command from the host; inserting a checksum into the transmission packet and transmitting the transmission packet to a network, and then receiving a packet from the network; checking if there is an error in a header and checksum of the received packet from the network; determining whether or not the received packet after said checking is harmful; and transmitting the received packet after said determining to the host.

### BRIEF DESCRIPTION OF THE DRAWINGS

The above and other objects and features of the present invention will become apparent from the following description of embodiments, given in conjunction with the accompanying drawings, in which:

FIG. 1 shows a block diagram of a packet transmission and reception processing apparatus in accordance with an embodiment of the present invention;

FIG. 2 illustrates a block diagram of an apparatus for preventing network attacks in accordance with an embodiment of the present invention;

FIG. 3 depicts a processing sequence of a method for preventing network attacks by the network attack prevention apparatus shown in FIG. 2;

FIGS. 4 and 5 are state diagrams showing a state transformation procedure of a TCP connection session used in the present invention;

FIG. 6 is a view showing a processing sequence for explaining a method for defending against SYN flooding attacks in the method for preventing network attacks in accordance with the present invention; and

FIGS. 7 to 11 are flowcharts showing a handling procedure of TCP packets received in accordance with the received packet handling procedure shown in FIG. 3, the state transformation procedure of a session shown in FIG. 4, and the network attack prevention procedure of FIG. 6, or a handling procedure of packets for a security function when forwarded.

FIGS. 12 to 15 are flowcharts showing a handling procedure of sending TCP packets in accordance with the state transformation procedure of a session shown in FIG. 5, and the network attack prevention procedure of FIG. 6, or a handling procedure of packets for a security function.

### DETAILED DESCRIPTION OF THE EMBODIMENTS

Hereinafter, embodiments of the present invention will be described in detail with the accompanying drawings.

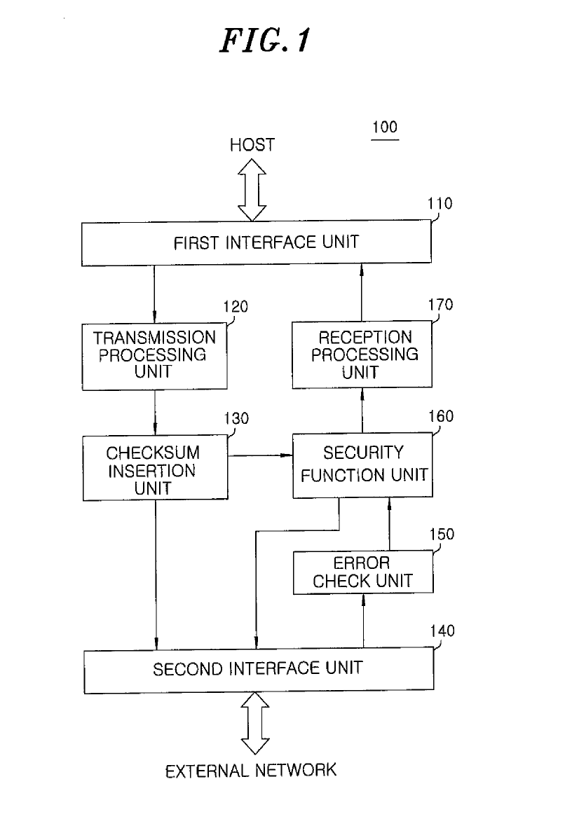

FIG. 1 is a block diagram of a packet transmission and reception processing apparatus implemented as a network card in accordance with an embodiment of the present invention.

The packet transmission and reception processing apparatus 100 in accordance with the present invention includes first and second interface units 110 and 140, a transmission processing unit 120, a checksum insertion unit 130, an error check unit 150, a security function unit 160, and a reception processing unit 170.

The first interface unit 110 provides a path for packet transmission and reception between the packet transmission and reception processing apparatus 100 and a host. For example, the first interface unit 110 may be implemented as a PCI-express (Peripheral Component Interconnect express) interface.

The transmission processing unit 120 reads out a transmission packet from a host via the first interface unit 110 in response to a transmission command from the host. That is, in response to a transmission command from a processor of the host, the transmission processing unit 120 reads out information of the transmission packet from the memory of the host via a direct memory access (DMA), and then reads out an actual packet through the DMA again using the information of the transmission packet.

The checksum insertion unit 130 inserts a checksum into the transmission packet transmitted from the transmission processing unit 120 and forwards it to a network via the second interface unit 140. At least one of an IP checksum and a TCP checksum or both of them are generated and inserted into the transmission packet. If TCP segmentation is needed, the transmission packet is segmented and the segmented packets are forwarded to the second interface 140. Connection information associated with the creation and deletion of sessions, i.e., TCP SYN, SYN-ACK, FIN and RST packets, are forwarded to the second interface unit 140 and the security function unit 160 as well to be used for management of TCP sessions.

The second interface unit 140 sends the transmission packet forwarded from the checksum insertion unit 130 to the network. Further, the second interface unit 140 receives the packet from the network and forwards it to the error check unit 150. For example, the second interface unit 140 may be implemented as a media access control (MAC) interface.

The error check unit 150 checks whether there is an error in a header of the received packet forwarded from the second interface unit 140. Upon completion of checking of the header, the received packet is forwarded to the security function unit 160 which determines whether or not the received packet is harmful during checking the checksum. In addition, the error check unit 150 has the function of extracting information of the packet required by the security function unit 160 and the reception processing unit 170. The checking of the checksum is completed only when the entire packet is received, i.e., from the first to the last byte of the packet. Thus, when the checking of the header is finished, the information of the packet is forwarded to the security function unit 160, and the checksum is calculated while the security function unit 160 checks on security problems of this packet.

The security function unit 160 determines whether or not the received packet from the error check unit 150 is harmful. To this end, the security function unit 160 performs at least one or all of an IP filtering function, an access control list (ACL) check function, and a distributed network attack defense function. This function unit 160 also provides an interface for adding a DPI (Deep Packet Inspection) function, and generates a TCP connection packet to forward it to the second interface unit 140.

The reception processing unit 170 sends the received packet forwarded from the security function unit 160 to the host via the first interface unit 110. That is, it sends the received packet to the memory of the host by using a DMA, and notifies the host processor of a transmission result thereof.

The packet transmission and reception processing apparatus 100 can be used as a network card which is mounted on the server to defend against attacks by packets received from a client. In this case, there is no need to check packets sent from the server to the network. Therefore, even when hardware performing a DPI function is added, it would be enough if a single direction bandwidth is covered. Only connection information associated with the creation and deletion of sessions is extracted from a packet sent from the server to the network, and used in the security function unit 160.

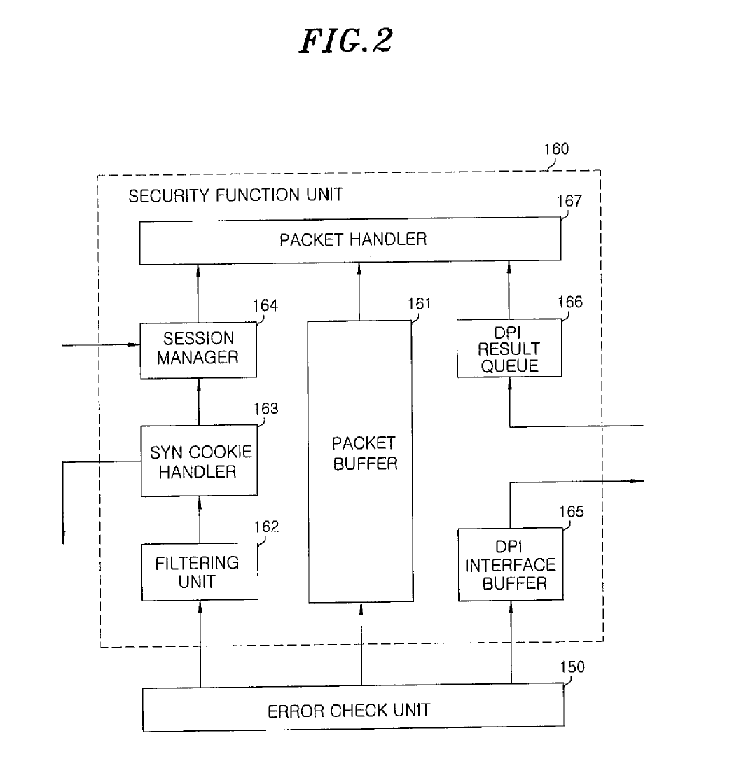

FIG. 2 is a block diagram of an apparatus for preventing network attacks in accordance with an embodiment of the present invention, which is implemented as the security function unit 160 of the packet transmission and reception processing apparatus 100 depicted in FIG. 1.

As shown therein, the security function unit 160 includes a packet buffer 161, a filtering unit 162, an SYN cookie handler 163, a session manager 164, a DPI interface buffer 165, a DPI result queue 166, and a packet handler 167.

The packet buffer 161 receives and stores packets forwarded from the network through the error check unit 150.

The filtering unit 162 filters harmful packets by performing several processes. These processes include: a black list check, ACL check and flooding check, and the filtered packet is chosen as a first filtering target packet.

To this end, the first filtering target packets are chosen based on a result of comparison between IP information of the packets received from the network and IP information of a preset black list, and additionally, harmful packets are selected depending on a result of ACL (Access Control List) check for comparing the information of the received packets and preset protocol, IP and port information. Thereafter, the received packets are applied different handing procedures depending on the type of the packets. For example, if the packets are, e.g., UDP or ICMP packets, the filtering unit 162 determines whether or not there is a UDP or ICMP flooding attack based on a result of comparison between a value of the frequency of UDP or ICMP packets and a preset value. Or, if the packets are, e.g., TCP packets, the session manager 164 determines whether or not there is a TCP flooding attack or not. This filtering unit 162 can detect some of DOS attack such as a smurf attack and these packets are filtered as well.

If it is determined that there is a TCP SYN flooding attack based on the information of the received packets after the filtering by the filtering unit 162, the SYN cookie handler 163 selects a second filtering target packet by using an SYN cookie. Here, if the information of the received packets after the filtering by the filtering unit 162 is associated with an SYN packet or a pure ACK packet, handling using the SYN cookie is performed. A pure ACK packet means an ACK packet without data payload.

The session manager 164 determines whether or not there is a TCP flag flooding attack based on the information of the received packets after the filtering by the filtering unit 162 to select a third filtering target packet through session management, and this session manager 164 determines whether or not there is a TCP SYN flooding attack based on a result of comparison between the number of sessions currently in an ACK standby state and a preset value. The determination result is sent to the SYN cookie handler 163. The session manager 164 classifies session states into invalid states and valid states for the purpose of session management, and also classifies the valid states into an ACK standby state, an SYN-ACK standby state, a disconnection standby state, and an active state. The SYN-ACK standby state or the disconnection standby state becomes the invalid state through timer management if there is no packet received during a predetermined time. Then, through the session management, all packets received for the current invalid session are selected as the third filtering target packet, while packets received for the active session are selected as the third filtering target packet when it is determined that there is an ACK flooding based on a result of comparison between a value of the frequency of an ACK packet and a preset value.

The packet handler 167 filters the first to third filtering target packets among the received packets stored in the packet buffer 161 and forwards the unfiltered received packets to the host, or forwards all the received packets stored in the packet buffer 161 to the host with information of filtering target packets.

The security function unit 160 so configured may further include the DPI interface buffer 165 and the DPI result queue 166. Here, the received packets stored in the packet buffer 161 are simultaneously stored in the DPI interface buffer 165, and the received packets stored in the DPI interface buffer 165 are forwarded to a DPI logic and resultant values thereof are fed back and stored in the DPI result queue 166. The packet handler 167 filters a harmful packet identified as containing harmful data based on the resultant value stored in the DPI result queue 166.

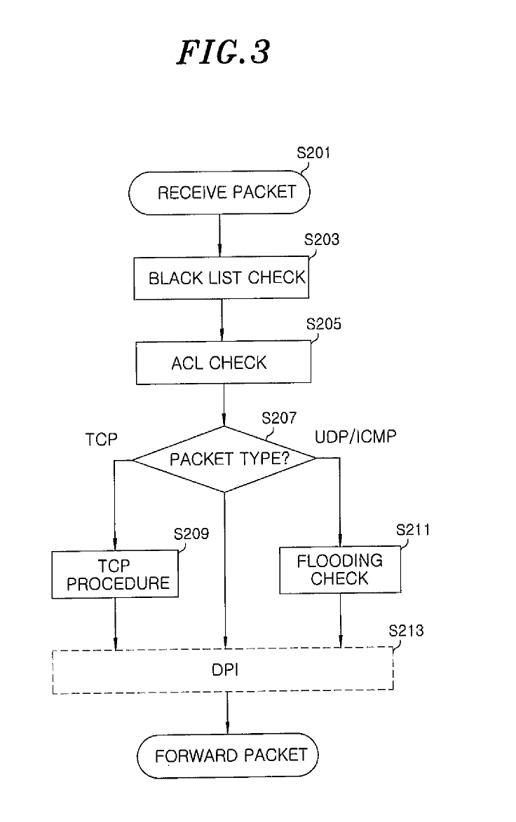

FIG. 3 shows a processing sequence of a method for preventing network attacks by the network attack prevention apparatus shown in FIG. 2, i.e., the security function unit 160.

First, when a received packet is forwarded to the security function unit 160 at step S201, the filtering unit 162 checks a black list at step S203. The black list is a list of IPs of harmful clients (e.g., zombie PCs) detected by the host processor by using software, which are to be blocked when reported to the packet transmission and reception processing apparatus 100 (e.g., a network card). The black list is used to block suspicious clients which are undetectable by hardware. If an ACL check alone is used, this requires enormous hardware resources, thus making it difficult to filter more than several thousands of IPs. The black list check is used to overcome this problem.

If the IP of the received packet is not present in the black list, the filtering unit 162 performs an ACL check at step S205. By the ACL check, packets designated by the host processor for protocols, ports or the like as well as IPs are filtered. Although not an ACL function, logic attacks (e.g., a SMURF attack) among network attacks are detected by a condition preset by hardware by the filtering unit 162.

After the filtering by the filtering unit 162, the type of the received packet is identified at step S207, and a handing procedure is varied depending on the identified type of the packet. First, in case of a TCP packet, the packet undergoes a TCP procedure at step S209, and selectively undergoes a deep packet inspection (DPI) at step S213. Then, if there is no harmful factor in the packet, the packet is forwarded to the reception processing unit 170 to execute reception DMA. The TCP procedure in step S209 will be described in more detail below.

In case of a UDP/ICMP packet, the packet undergoes a flooding check at step S211, and selectively undergoes a DPI at step S213. Then, if there is no harmful factor in the packet, the packet is forwarded to the reception processing unit 170 to execute reception DMA. This step S211 involves the function of checking the frequency of a UDP/ICMP packet, determining that there is a flooding attack if the frequency exceeds a predetermined value, and preventing the flooding attack.

In case of other packets, a packet selectively undergoes a DPI. Then, if there is no harmful factor in the packet, the packet is forwarded to the reception processing unit 170.

The DPI function at step S213 can only support an interface. This is to attach a chip performing the DPI function to the outside or to encode data into a single chip by a hardware description language (HDL) if the chip used has enough capacity. Moreover, it can be chosen whether to forward the entire packet or only the data portion excluding the header.

The TCP procedure at step S209 is used to defend against TCP flooding attacks through session management. The TCP flooding attacks to be defended against are roughly divided into two types. The first type includes SYN flooding attacks, and the second type includes other flag-flooding attacks.

In a method for preventing a flag flooding attack, through session management, all TCP packets received for the current invalid session are filtered, while packets received for the active session are filtered when it is determined that there is an ACK flooding after checking whether or not the frequency of an ACK packet exceeds a predetermined value.

The session management can be simplified to only determine whether the corresponding packet is in a receivable state or in an unreceivable state.

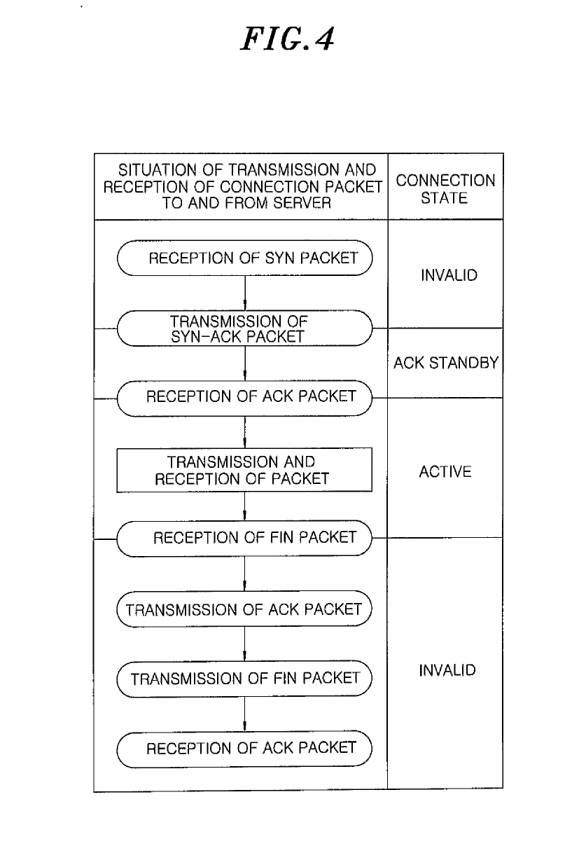

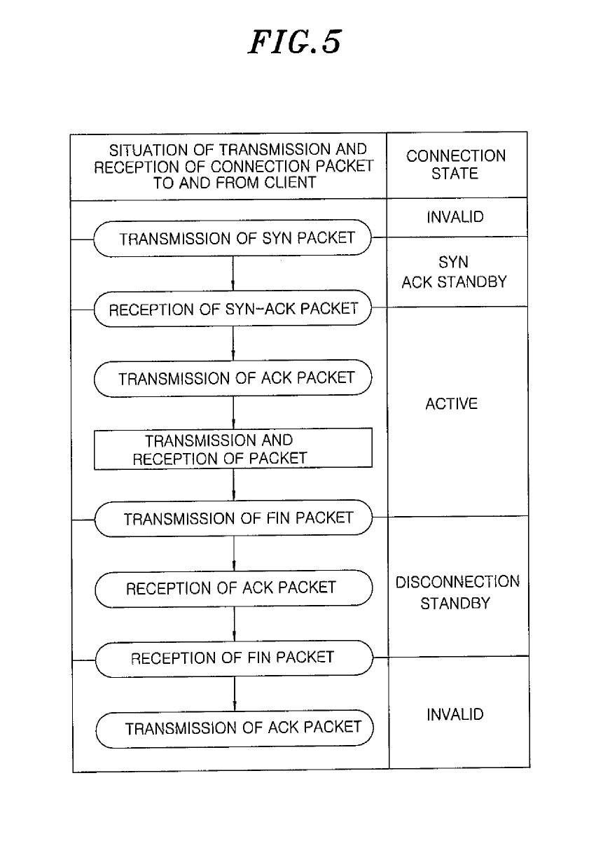

FIGS. 4 and 5 are state diagrams showing a TCP connection in accordance with the present invention.

As shown in FIG. 4, in case of a server, the server receives an SYN packet and sends an SYN-ACK packet, and then the session is changed to an ACK standby state. In this state, only ACK packets with no payload can be received. At this point, upon receipt of an ACK packet, an active session is created. Thereafter, all packets are received until a FIN packet is received. Upon receipt of the FIN packet, the session turns into an invalid state and thus it is determined that the corresponding session has disappeared, thereby discarding all the received packets. At this time, although the reception of an ACK packet after the transmission of the FIN packet is also made impossible, there is no problem in the operation even if the server receives no ACK packet after sending the FIN packet. When defending against a flag flooding attack, it may be also possible to receive an ACK packet by eliminating the packet when it occurs with more than a predetermined frequency, rather than unconditionally eliminating the packet.

As shown in FIG. 5, in case of a client, the client sends an SYN (connection request) packet and then the session is changed to an SYN-ACK standby state. Only a session in this state can receive an SYN-ACK packet, and other packets are discarded. Upon receipt of an SYN-ACK packet, an active session is created, and the transmission and reception of the packet are performed. Once the session sends a FIN packet, the session is changed to a disconnection standby state. The operation of the disconnection standby state is not different from that in an active state. Once the FIN packet is received, the corresponding session is changed to an invalid state and discarded.

As shown in FIGS. 4 and 5, valid states are classified into a total of four states: an ACK standby state; an SYN-ACK standby state; a disconnection standby state; and an active state. Upon receipt of a RST packet in a valid state, the session is changed to an invalid state. Among those states, the SYN-ACK standby state and the disconnection standby state are characterized in that, unless packet transmission and reception are performed during a predetermined time through timer management, the session returns to the invalid state.

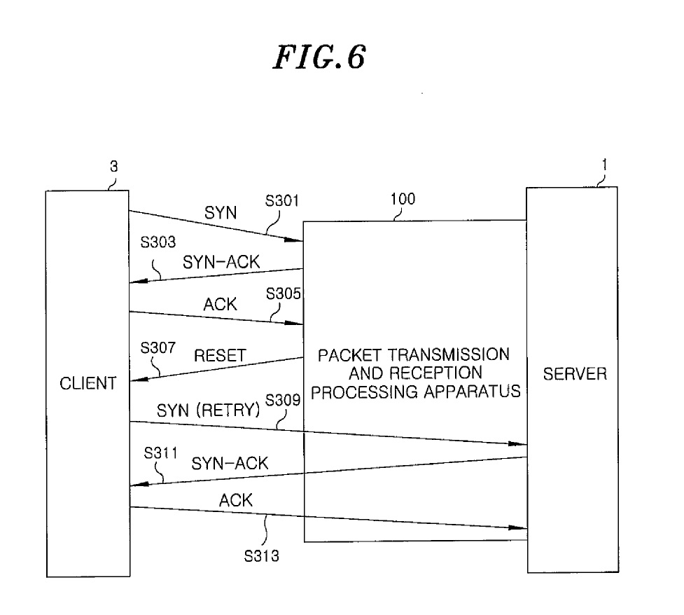

FIG. 6 shows a processing sequence for explaining a method for defending against SYN flooding attacks in the method for preventing network attacks in accordance with the present invention, which illustrates a case where the packet transmission and reception processing apparatus 100 in accordance with the present invention defends against an attack on a server 1 from a client 3.

Whether there is an SYN flooding attack going on or not is determined depending on whether the number of sessions currently in the ACK standby state exceeds a preset value or not. If it is determined that there is an SYN flooding attack going on, an SYN cookie algorithm is operated from then on.

When the packet transmission and reception processing apparatus 100 receives an SYN packet from the client 3 at step S301, it determines by searching a white list whether the IP that transmitted the SYN packet is a safe IP or not. If it is determined that the IP is a safe IP, the SYN packet is passed to the server 1. If not, a packet sequence number encoded by a key value changing at intervals of several seconds is embedded in an SYN-ACK packet and transmitted to the client 3, and then the received packet is discarded at step S303. When an SYN flooding state is just started, no IP exists in the white list and thus the packet sequence number transmission to the client 3 at step S303 is performed.

If there is no IP spoofing, the SYN-ACK packet returns to the client 3 that has sent the SYN packet, and if the corresponding computer has no intention of an SYN flooding attack, it transmits an ACK packet in step S305. Upon receipt of this ACK packet, the ACK number is verified by using the current key value and the previous key value. If the ACK number is determined as being correct, the corresponding IP is registered in the white list, and then a RST packet is transmitted again at step S307. Although a typical SYN cookie is operated in the protocol stack of the server 1, a SYN cookie in the present invention is implemented in the packet transmission and reception processing apparatus 100 (e.g., a network card) between the server 1 and the client 3. Thus, a TCP option or a sequence number cannot be arbitrarily determined. Therefore, at the time of the next connection after the current connection is finished, the server 1 determines connection information by using the RST packet.

Although the client 3 that has received the RST packet fails in connection, most users will retry a connection once again, and an SYN packet is received by the retry at step S309. The IP of the received SYN packet is normally received by the server 1 because it is registered in the white list. Thereafter, at steps S311 and S313, the server 1 and the client 3 send and receive an SYN-ACK packet and an ACK packet, thereby establishing a connection.

After a certain length of time, if the session of the ACK standby state is reduced, it is determined that there is no SYN flooding attack going on, and, in this case, the white list is initialized. By this method, the possibility of a problem caused by an attack from an IP registered in the white list long ago can be avoided. Moreover, only an IP attempting a safe connection is stored in the white list, and therefore the number of lists to be stored can be reduced much compared to a method of tracking all connection attempts.

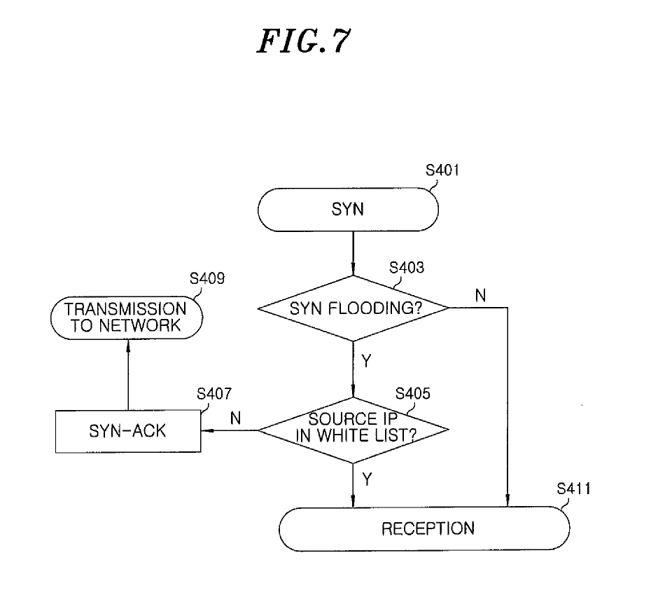

FIGS. 7 to 11 are flowcharts showing a handling procedure of TCP packets received in accordance with the received packet handling procedure shown in FIG. 3, the state transformation procedure of a session shown in FIG. 4, and the network attack prevention procedure of FIG. 6, or a handling procedure of packets for a security function when forwarded.

Referring to FIG. 7, if an SYN packet is received at step S401, firstly, it is determined whether the current state is an SYN flooding state or not at step S403. Whether the current state is an SYN flooding state or not is determined based on the number of sessions currently in an ACK standby state. In case of the SYN flooding state, it is determined at step S405 whether or not a source IP exists in the white list. If not, an SYN-ACK packet is generated on its own by using a key value at step S407, and transmitted to a network at step S409. If the current state is not an SYN flooding state or a source IP exists in the white list, the SYN packet is regarded as being normal and passed at step S411.

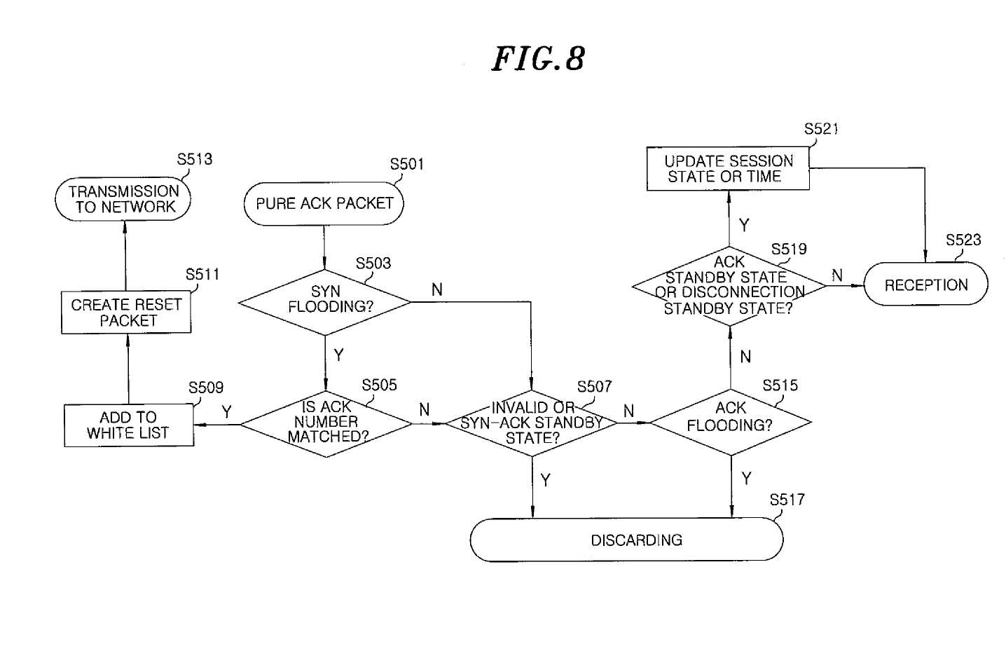

Referring to FIG. 8, if a pure ACK packet is received at step S501, firstly, it is determined at step S503 whether the current state is an SYN flooding state or not. In case of the SYN flooding state, the ACK number of the received packet is checked at step S505. If the ACK number thereof matches a sequence number generated by using the key value when the SYN packet is received, it is determined that an ACK packet based on an SYN cookie algorithm is safely received. Thus, it is determined that a source IP attempting a connection has no intention of attacking, the corresponding IP is added to the white list at step S509, and then a RST packet is generated at step S511 and transmitted to a network at step S513 to induce the source IP to retry a connection. If the current state is not an SYN flooding state or the ACK number is not a number based on the SYN cookie algorithm, a session table is searched to check the state of the corresponding session at step S507. If the session is in an invalid state (i.e., it does not exist in the table), or in an SYN-ACK standby state, the corresponding packet is considered as an attack and discarded at step S517.

In case of other states, the frequency of reception of an ACK packet is checked to determine if there is an ACK flooding attack at step S515. If the frequency of reception of the ACK packet exceeds a predetermined value, it is determined that there is an ACK flooding attack, and the packet is discarded in step S517. Otherwise, the packet is determined as being normal and passed to step S519. In case of the ACK standby state, an operation of changing the state of the session to an active state is performed, and in case of a disconnection standby state, an operation of updating the timer is additionally performed in step S521.

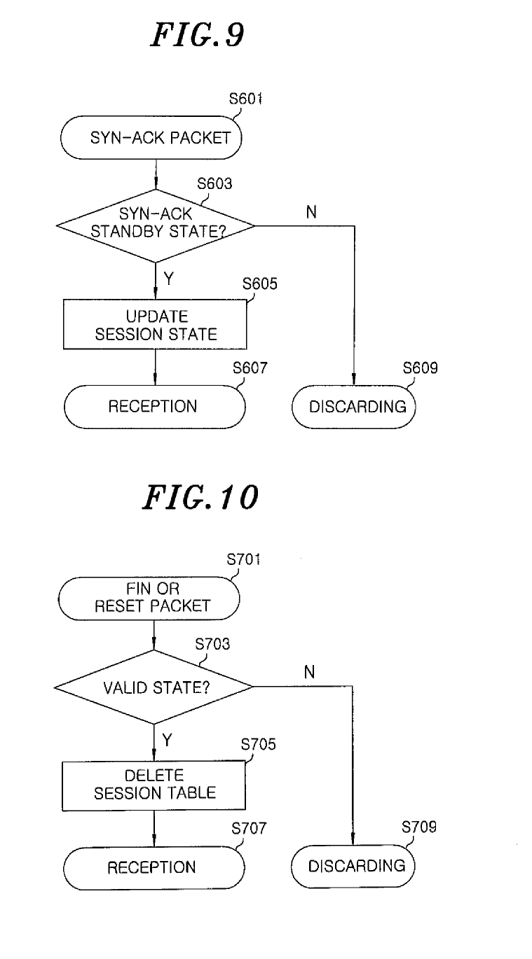

Referring to FIG. 9, if an SYN-ACK packet is received at step S601, firstly, the session table is searched at step S603. If the corresponding session is not in the SYN-ACK standby state, the packet is discarded at step S609. If the corresponding session is in the SYN-ACK standby state, the state of the session is changed to the active state and the packet is received (or passed) at step S607.

Referring to FIG. 10, if a FIN packet or a RST packet is received at step S701, the session table is searched as well at step S703. If the corresponding session is in a valid state, the session table is deleted at step S705 and then the packet is passed at step S707. If the corresponding session is in an invalid state (i.e., no session is searched), the packet is discarded at step S709.

Referring to FIG. 11, if other packets (i.e., all packets except which are mentioned in FIGS. 7 to 9) are received at step S801, the session table is searched at step S803 as well. The packets are passed only when the session is in the active state or in the disconnection standby state. If the session is in other states or in the invalid state (i.e., no session is searched), the packets are discarded at step S805. If the session is in the disconnection standby state, an operation of updating the timer is additionally performed at step S809 and the packets are received (or passed) at step S811.

For the management of session states, several TCP packets to be transmitted, in addition to the received TCP packets, are required. These TCP packets include an SYN packet, an SYN-ACK packet, a FIN packet, and a RST packet. The checksum insertion unit 130 in FIG. 1 forwards the corresponding information to the security function unit 160. FIGS. 12 to 15 show a handling procedure of these packets when forwarded.

Referring to FIG. 12, when an SYN packet is transmitted at step S901, the corresponding session is created in the session table, and the state of the created session is set to the SYN-ACK standby state at step S903. In addition, in step S905. A timer is set such that hardware can delete it when no packet is received later.

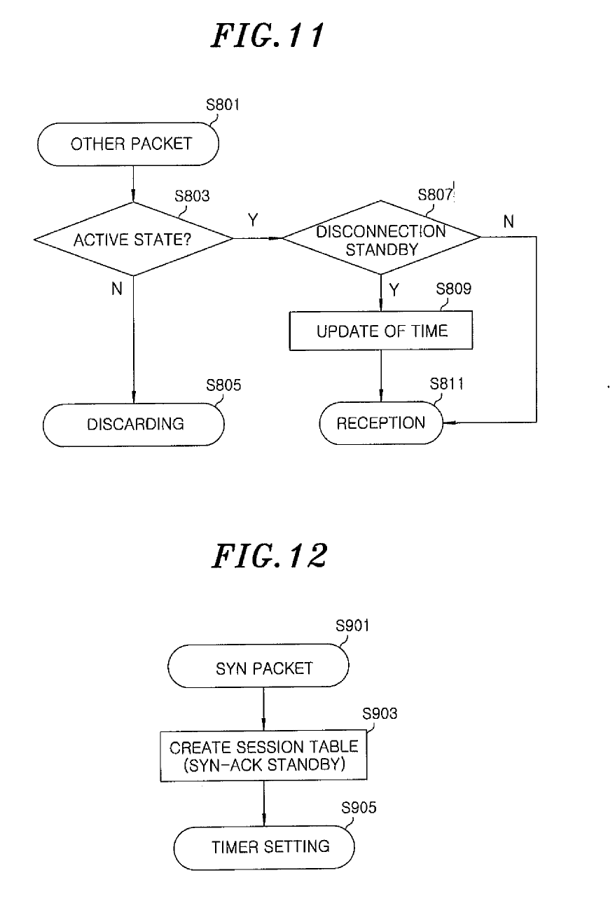

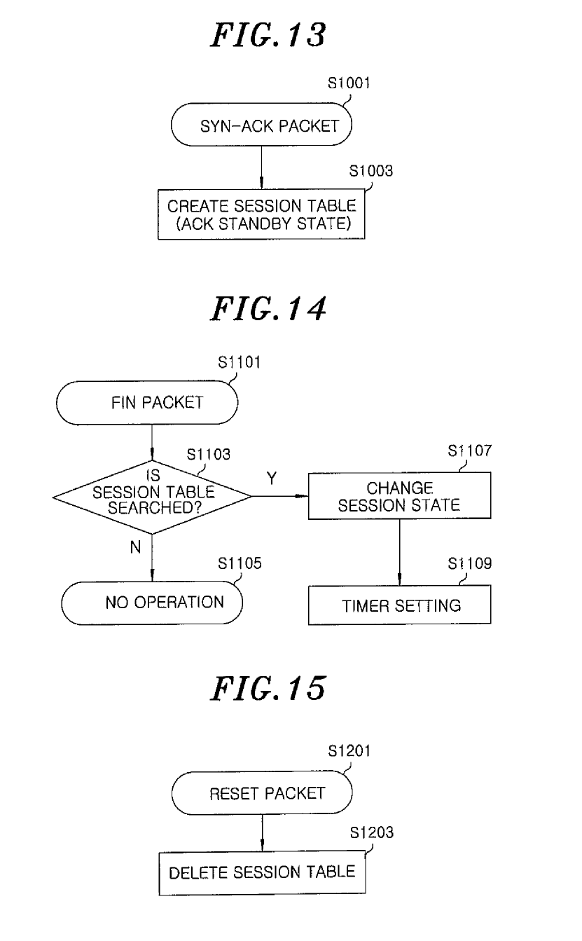

Referring to FIG. 13, when an SYN-ACK packet is transmitted at step S1001, the corresponding session is created in the session table at step S1003, in which the state of the created session is set to the ACK standby state.

Referring to FIG. 14, when a FIN packet is transmitted in step S1101, firstly, the session table is searched at step S1103. If no session is searched, this means that the other node of the connection has first made a request for disconnection, therefore no operation is performed at step S1105. If a session is searched, the state of the corresponding session is changed to the disconnection standby state and a timer is set at step S1109.

Referring to FIG. 15, when a RST packet is transmitted at step S1201, the corresponding session is deleted from the session table at step S1203.

In accordance with the present invention, network attacks can be defended against without using a large memory in the event of defense against network attacks, such as SYN flooding or IP spoofing attacks, and a new connection can be established after IP verification using an initial connection attempt, thereby it could be handled regardless of a TCP option and requires no PSN management.

In addition, by implementing a network attack prevention apparatus by hardware such as a network card on a server, it is possible to deal with network attacks without expensive network security equipment and improve the level of defense against attacks compared to a conventional method using software. Moreover, since hardware determines whether a connection is normal or not, almost no attack packet from the network is delivered to the server, thus no burden is given to the server.

Furthermore, a large number of IPs, which cannot be covered by an ACL alone, can be managed by using a black list that can be designated by the server in order to deal with modified versions of distributed network attacks which cannot be prevented by hardware.

Besides, various network attacks can be dealt with through ACL and session management, an interface with hardware capable of separately executing a DPI function is provided to extend the DPI function, and network protocol handling can be properly performed using a network accelerating function.

While the present invention has been particularly shown and described with reference to exemplary embodiments thereof, it will be understood by those skilled in the art that various changes in form and details may be made therein without departing from the scope of the present invention.

What is claimed is:

1. An apparatus for preventing network attacks, comprising:
a filtering unit for filtering harmful packets based on a result of comparison between information of the received packets and preset filtering information to select a first filtering target packet if it is determined that there is a user datagram protocol (UDP) or Internet control message protocol (ICMP) flooding attack based on the information of the received packets after the filtering;
an SYN cookie handler for selecting a second filtering target packet using an SYN cookie if it is determined that there is a transmission control protocol (TCP) SYN flooding attack based on the information of the received packets after said filtering;
a session manager for selecting a third filtering target packet through session management if it is determined that there is a TCP flag flooding attack based on the information of the received packets after said filtering; and
a packet handler for filtering the first to third filtering target packets among the received packets stored in the packet buffer to forward unfiltered received packets to the host, or forwarding all the received packets stored in the packet buffer to the host with the information of filtering target packets.

2. The apparatus of claim 1, wherein the filtering unit performs a filtering harmful packets based on a result of comparison between the IP information of the received packets from the network and IP information of a preset black list, and performs an additional filtering on the harmful packets based on a result of access control list (ACL) check comparing the information of the received packets and preset IP, protocol information and port information.

3. The apparatus of claim 1, wherein, when the received packets after a black list check and an ACL check are a UDP or ICMP packet, the filtering unit determines whether or not there is the UDP or ICMP flooding attack based on a result of comparison between a value of the frequency of the UDP or ICMP packet and a preset value.

4. The apparatus of claim 1, wherein, after sending a SYN-ACK packet, the session manager determines whether or not there is the TCP SYN flooding attack based on a result of comparison between the number of sessions currently in an ACK standby state and a preset value to send a determination result to the SYN cookie handler.

5. The apparatus of claim 1, wherein, if the information of the received packets after the filtering is an SYN packet or pure ACK packet, the SYN cookie handler performs handling based on the SYN cookie.

6. The apparatus of claim 1, wherein the session manager classifies session states into invalid states and valid states for the session management, and classifies the valid states into an ACK standby state, an SYN-ACK standby state, a disconnection standby state and an active state.

7. The apparatus of claim 1, wherein, through the session management, the session manager selects all packets received for the current invalid session as the third filtering target packet, and selects packets received for the active session as the third filtering target packet when it is determined that there is an ACK flooding based on a result of comparison between a value of the frequency of an ACK packet and a preset value.

8. The apparatus of claim 1, further comprising:
a deep packet inspection (DPI) interface buffer for simultaneously storing the received packets stored in the packet buffer; and
a DPI result queue for, after the received packets stored in the DPI interface buffer are forwarded to a DPI logic, receiving and storing resultant values,
wherein the packet handler filters a harmful packet based on the resultant values.

9. A method for preventing network attacks, comprising:
filtering harmful packets based on a result of comparison between information of received packets from a network and preset filtering information;
selecting a first filtering target packet if it is determined that there is a UDP or ICMP flooding attack based on the information of the received packets after the filtering;
selecting a second filtering target packet using an SYN cookie if it is determined that there is a TCP SYN flooding attack based on the information of the received packets after the filtering;
selecting a third filtering target packet through session management if it is determined that there is a TCP flag flooding attack based on the information of the received packets after the filtering; and
filtering the first to third filtering target packets among the received packets from the network to forward the unfiltered received packets to a host, or forwarding all the received packets to the host with the information of filtering target.

10. A method for preventing network attacks, comprising:
determining whether or not there is a TCP SYN flooding attack based on a count of sessions in ACK standby state;
if it is determined that there is the TCP SYN flooding attack, determining whether or not the client is safe by using an SYN cookie;
storing an IP of the normal client in a white list and then making a disconnection by transmitting a reset packet;
when a connection request packet is received again, forwarding, to a server, a result of checking if the IP of the packet is stored in the white list to establish a connection with the client; and
when the state of the TCP SYN flooding attack is released, initializing the white list.

11. A packet transmission and reception processing apparatus, the apparatus comprising:
a first interface unit for providing a path for packet transmission and reception to and from a host;
a transmission processing unit for reading out a transmission packet from the host via the first interface unit in response to a transmission command from the host;
a checksum insertion unit for inserting a checksum into the transmission packet from the transmission processing unit and forwarding the transmission packet;
a second interface unit for sending the transmission packet forwarded from the checksum insertion unit to a network and receiving the packet from the network;
an error check unit for checking if there is an error in a header and checksum of the received packet forwarded from the second interface unit;
a security function unit for determining whether or not the received packet forwarded from the error check unit is harmful; and
a reception processing unit for sending the received packet forwarded from the security function unit to the host via the first interface unit.

12. The apparatus of claim 11, wherein the transmission processing unit reads out information of the transmission packet from a memory of the host through a direct memory access (DMA) in response to the transmission command from a processor of the host, and reads out an actual packet through the DMA again using the information of the transmission packet.

13. The apparatus of claim 11, wherein the checksum insertion unit generates at least one of IP checksum and TCP checksum and inserts it into the transmission packet.

14. The apparatus of claim 11, wherein, when TCP segmentation is required, the checksum insertion unit segments the transmission packet and forwards segmented packets to the second interface unit.

15. The apparatus of claim 11, wherein the error check unit forwards the received packet to the security function unit upon completion of checking of the header so that the security function unit determines whether or not the received packet is harmful during checking the checksum.

16. The apparatus of claim 11, wherein the security function unit performs at least one of an IP filtering function, an access control list (ACL) check function, and a distributed denial of service (DDOS) attack defense function.

17. The apparatus of claim 11, wherein the security function unit provides an interface to add a deep packet inspection (DPI) function.

18. The apparatus of claim 11, wherein the security function unit generates a TCP connection packet and forwards the packet to the second interface unit.

19. The apparatus of claim 11, wherein the reception processing unit transmits the received packet to the memory of the host using the DMA and reports the transmission result to the host processor.

20. A packet reception processing method, the method comprising:
checking if there is an error in a header and checksum of a received packet from a network;
determining whether or not the received packet after said checking is harmful; and
transmitting the received packet after said determining to a host which transmitted the received packet.
